(19) United States
(12) Patent Application Publication
(10) Pub. No.: US 2011/0310039 A1
(43) Pub. Date: Dec. 22, 2011

(54) METHOD AND APPARATUS FOR USER-ADAPTIVE DATA ARRANGEMENT/CLASSIFICATION IN PORTABLE TERMINAL

(75) Inventor: Mi-Ra KIM, Gyeongsangbuk-do (KR)

(73) Assignee: SAMSUNG ELECTRONICS CO., LTD., Gyeonggi-Do (KR)

(21) Appl. No.: 13/161,575

(22) Filed: Jun. 16, 2011

(30) Foreign Application Priority Data
Jun. 16, 2010 (KR) 10-2010-0057023

(51) Int. Cl. G06F 3/041

(52) U.S. Cl. 345/173

(57) ABSTRACT

A method and an apparatus for user-adaptive data arrangement/classification in a portable terminal. The method preferably includes: displaying all data elements stored in the portable terminal, and setting arrangement priorities of the displayed data elements by giving a tag to each displayed data element. Each displayed data element is captured and given the tag as an image; identifying the tag given to each displayed data element, and arranging and storing the captured images in unique priorities for each type of the tags; and grouping the stored images respectively given the tags according to the tag types.

### CLAIM OF PRIORITY

This application claims priority under 35 U.S.C. §119(a) from a Korean Patent Application entitled “Method and Apparatus for User-Adaptive Data Arrangement/Classification in Portable Terminal” filed in the Korean Intellectual Property Office on Jun. 16, 2010 and assigned Serial No. 10-2010-0057023, the contents of which are incorporated herein by reference in its entirety.

### BACKGROUND OF THE INVENTION

1. Field of the Invention

The present invention relates to a portable terminal employing a touch-screen. More particularly, the present invention relates to a method and an apparatus for the arrangement and classification of e multiply displayed data elements.

2. Description of the Related Art

Recent advances in technology coupled with increased consumer need have accelerated the development of portable terminals into multimedia devices which can provide various additional services beyond voice communication. For example, such multimedia devices can provide a text message transmission/reception function, a camera function, an MP3 (Moving Picture Experts Group Layer 3) player function, an electronic organizer function, a game function, a schedule management function, video message and Internet access functions, etc. Commensurate with such increased functionality, the types and the amount of data requiring storage in the portable terminals have increased in response to the various additional services provided by the portable terminals as described above.

Also, the portable terminals now often include touch-screens that have increased capability in response to the designs thereof which have become diversified and miniaturized.

During normal operation of a portable terminal, when data elements are displayed on a touch-screen, a user can check desired data elements by using scroll bars, or by moving a finger or stylus along a display area, or by inputting letters through a keypad displayed on the touch-screen. Namely, when the user selects data elements such as a phone directory and a call log, the portable terminal displays the selected data elements as a list. Then, when the user drags a scroll bar or inputs search words by accessing the keypad in order to search for desired data elements, the portable terminal checks data elements selected by dragging the scroll bar or data elements selected by inputting the search words among the data elements displayed as the list. Next, the portable terminal simultaneously displays the checked data elements and data elements adjacent to the checked data elements.

However, in the data display scheme as described above, the larger the amount of data elements stored in the portable terminal becomes, the more time it takes to search for and display data elements that the user desires. Besides the above inconvenience, it is also inconvenient for the user to check the data elements stored in the portable terminal one-by-one in order to search for the desired data elements.

Also, the portable terminal has a problem in that the stored data elements are arranged and classified in a group only by the predetermined data characteristics, i.e. file names, file generation dates, data sizes, etc.

### SUMMARY OF THE INVENTION

Accordingly, the present invention provides a method and an apparatus for user-adaptive data arrangement/classification in a portable terminal, in which a touch-screen of the portable terminal displays multiple data elements stored in the portable terminal, and a user marks the multiple displayed data elements by directly writing letters or numerals on them, so that the user can adaptively arrange and classify the multiple displayed data elements, departing from a scheme for arranging and classifying multiple data elements in a lump based on the existing file names, file generation dates, data sizes, etc.

In accordance with an exemplary aspect of the present invention, there is provided a method for user-adaptive data arrangement in a portable terminal, the method preferably including: displaying all data elements stored in the portable terminal, and setting arrangement priorities of the displayed data elements by giving a tag to each displayed data element; capturing each displayed data element given the tag as an image; identifying the tag given to each displayed data element, and arranging and storing the captured images in unique priorities for each type of the tags; and grouping the stored images respectively given the tags according to the tag types.

In accordance with another exemplary aspect of the present invention, there is provided a method for user-adaptive data classification in a portable terminal, the method preferably including: displaying data elements stored in the portable terminal, and receiving a tag given to at least one data element among the displayed data elements by the user; identifying the tag given to the at least one data element, and searching for whether tags having an equal tag type, which the identified tag has, have been previously stored; and connecting the identified tag with previously-stored tags, and grouping and classifying the identified tag as the equal tag type, when a result of the search shows that the tags having the equal tag type exist.

Also, in accordance with another exemplary aspect of the present invention, there is provided an apparatus for user-adaptive data arrangement/classification in a portable terminal, the apparatus preferably including: a touch-screen; an image capturer; and a controller for displaying all data elements on the touch-screen, setting arrangement priorities of the displayed data elements by giving a tag to each displayed data element, controlling the image capturer to capture each displayed data element given the tag as an image, identifying the tag given to each displayed data element, arranging the captured images in unique priorities for each type of the tags and controlling a storage unit to store the arranged images, and grouping the stored images respectively given the tags according to the tag types.

### BRIEF DESCRIPTION OF THE DRAWINGS

The above and other exemplary features, aspects, and advantages of the present invention will become more apparent from the following detailed description taken in conjunction with the accompanying drawings, in which:

FIG. 1 is a flowchart showing a method for user-adaptive data arrangement in a portable terminal according to an exemplary embodiment of the present invention;

FIG. 2 is a flowchart showing a method for user-adaptive data classification in a portable terminal according to an exemplary embodiment of the present invention;

FIG. 3 is a block diagram illustrating the configuration of an apparatus for user-adaptive data arrangement/classification in a portable terminal according to an exemplary embodiment of the present invention;

FIGS. 4A and 4B are illustrative views showing data elements displayed on a touch-screen that a user marks with his/her handwriting as input during user-adaptive data arrangement/classification in a portable terminal according to an exemplary embodiment of the present invention; and

FIGS. 5A and 5B are illustrative views showing screen images of a touch-screen to which a method for user-adaptive data arrangement/classification is applied in a portable terminal according to an exemplary embodiment of the present invention.

### DETAILED DESCRIPTION

Hereinafter, exemplary embodiments of the present invention will be described in detail with reference to the accompanying drawings. The following detailed description includes specific details, and the specific details are only provided in order to help more comprehensive understanding of the present invention. Therefore, it is apparent to those skilled in the art that variations in form and details may be made in the specific details without departing from the spirit of the invention and the scope of the appended claims.

A portable terminal according to an exemplary embodiment of the present invention employs a touch-screen. The present invention in an exemplary aspect permits a touch-screen of the portable terminal to display multiple data elements stored in the portable terminal, and the portable terminal permits the user to mark the multiple displayed data elements by directly writing letters or numerals on them, so that the user can adaptively arrange and classify the multiple displayed data elements, departing from a scheme for arranging and classifying multiple data elements in a predetermined group based on the existing file names, file generation dates, data sizes, etc.

Hereinafter, in describing the present invention, “data” signifies all data which can be stored in the portable terminal. The data may include data, such as a user phone number, a photograph, a moving picture or an image, a call log, an MP3 (Moving Picture Experts Group Layer 3) file, etc., which are downloaded through another terminal or the Internet, etc., data which is directly input by a user and is stored in the portable terminal, data generated while the portable terminal performs a function, etc.

It is preferable but not required that the portable terminal according to an exemplary embodiment of the present invention is a mobile communication terminal. Also, a person of ordinary skill in the art can appreciate that the present invention can be applied to all types information communication devices and all types multimedia devices, including a digital broadcasting terminal, a PDA (Personal Digital Assistant), a smart phone, and 3G (third generation) terminals, for example, an IMT-2000 (International Mobile Telecommunication 2000) terminal, a WCDMA (Wideband Code Division Multiple Access) terminal, a GSM/GPRS (Global System for Mobile Communications/General Packet Radio Service) terminal, and a UMTS (Universal Mobile Telecommunication Service) terminal, etc., and can be applied to applications of all the information communication devices and all the multimedia devices.

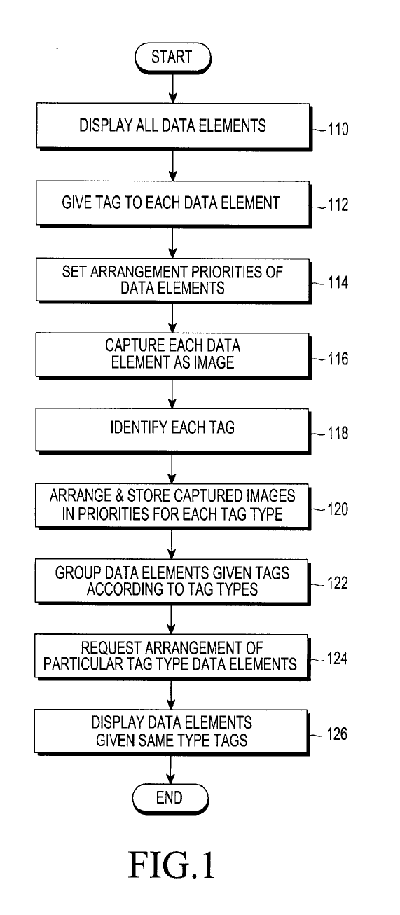

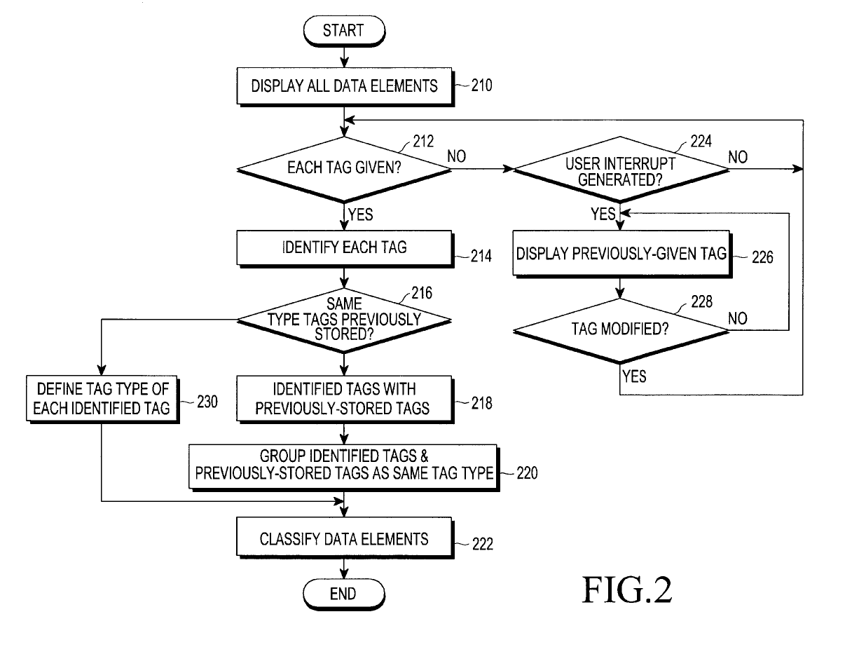

Hereinafter, a method for user-adaptive data arrangement/classification in a portable terminal according to an exemplary embodiment of the present invention will be described in detail with reference to FIGS. 1 and 2.

FIG. 1 is a flowchart showing a method for user-adaptive data arrangement in a portable terminal according to an exemplary embodiment of the present invention.

Referring now to FIG. 1, in step 110, a current mode of the portable terminal is switched and set to a data arrangement mode, and all stored data elements are displayed on a touch-screen in the portable terminal.

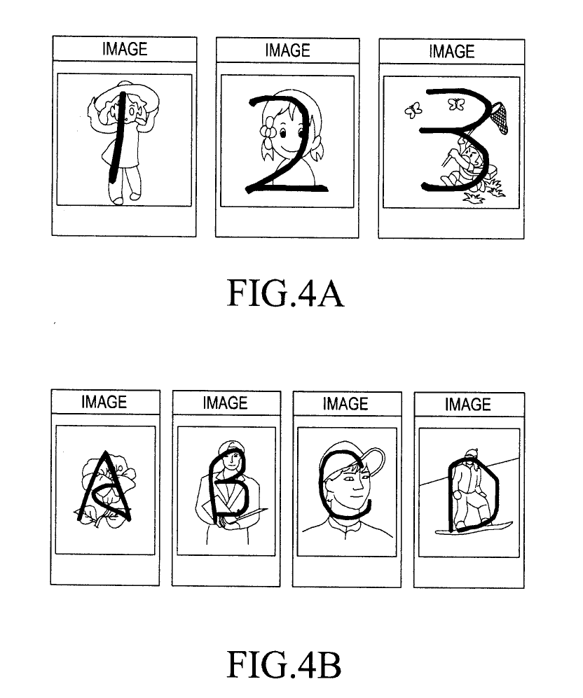

In step 112, a tag is given to each displayed data element as shown in FIGS. 4A and 4B. In step 114, arrangement priorities of the displayed data elements are set.

In this particular case, the tag given to each displayed data element in step 112 signifies a letter or a numeral that a user writes in order to mark each displayed data element and is given a unique order. For example, the tags include A, B, C, D, . . . according to a unique arrangement order of capital English letters, a, b, c, d, . . . according to a unique arrangement order of small English letters, [symbol] , [symbol] , [symbol] , [symbol] , . . . according to a unique arrangement order of Korean language Hangeul, and 1, 2, 3, 4, . . . according to the ascending arrangement of natural numbers. At this time, the tags A, B, C, D, . . . have capital English letters as their tag type. The tags a, b, c, d, . . . have small English letters as their tag type. The tags [symbol] , [symbol] , [symbol] , [symbol] , . . . have Hangeul as their tag type.

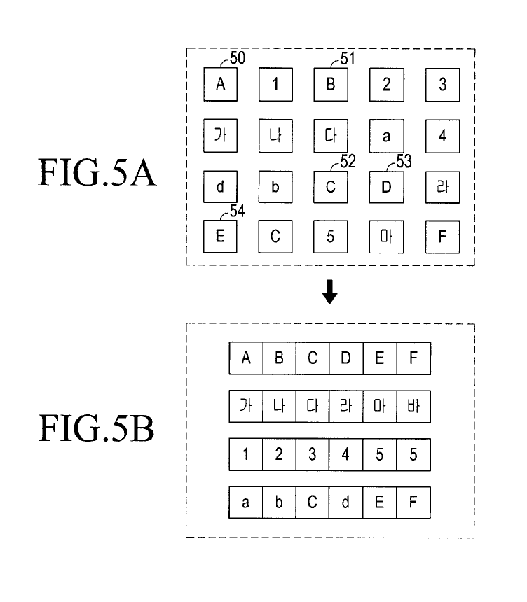

Also, the user can set an arrangement priorities of the displayed data elements as follows. When a user intends to classify only predetermined data elements among the multiple data elements displayed on the touch-screen according to the tag types, e.g., as shown in FIGS. 5A, 5B, when the user intends to classify the predetermined data elements among the multiple data elements displayed on the touch-screen as data elements having only capital English letters as their tag type, and intends to distinguish the predetermined data elements from the multiple displayed data elements, he/she can mark displayed data elements 50, 51, 52 and 53 by directly writing letters or numerals on them by using a user input means (e.g. a finger or a stylus pen) as shown in FIG. 5A.

By directly writing letters or numerals on the displayed data elements, the user can classify only the predetermined data elements from among the multiple displayed data elements as the data elements having, for example, capital English letters as their tag type. Further, similarly to the above exemplary embodiment, when the user intends to classify only predetermined data elements among the multiple displayed data elements as either data elements having small English letters as their tag type, data elements having Hangeul as their tag type, or data elements having numerals as their tag type, he/she can also directly write tags belonging to a desired tag type on predetermined data elements, which he/she intends to classify, in order to mark them, and thereby can adaptively set arrangement priorities of the predetermined data elements.

As described above, data elements, which are given tags according to the tag types, i.e. of which arrangement priorities are set, among the multiple data elements displayed on the touch-screen shown in FIG. 5A, are arranged according to the tag types as shown in FIG. 5B. The data elements may be displayed on the touch-screen or may be stored in a memory depending on the selection of the user.

In step 116, each displayed data element given a tag is captured as an image. In step 118, the tag, which is given to each displayed data element captured as the image, is identified. At this time, the tag, which is given to each displayed data element, is identified by comparing the tag, which is formed on each displayed data element that the user marks with his/her handwriting, based on images of the subordinate tag items (i.e. either A, B, C, D, . . . a, b, c, d, . . . or 1, 2, 3, 4, . . . ) according to the previously-designated tag types.

Namely, when a data arrangement operation is initialized, the user directly inputs his/her own handwriting as a tag, and the subordinate tag items according the tag types are captured as images. The captured images of the subordinate tag items that were previously stored are arranged according to tag types.

Other than the aforementioned operation, when the data arrangement operation is initialized, the portable terminal includes a database related to the tags, such as letters or numerals, arranged in their unique priorities. Accordingly, when the user marks the predetermined data elements by writing letters or numerals on them, the written letters or numerals as the tags are identified by comparing and checking them with the stored subordinate tag items according to the tag types.

The tags, which have been identified in step 118, are arranged and stored in the portable terminal in unique priorities for each tag type, as shown in FIG. 5B (step 120).

In step 122, the displayed data elements, which have been respectively given different tags arranged in the unique user designated priorities for each tag type, are grouped according to the tag types.

In step 124, a data arrangement request is input by the user so that only data elements of a particular tag type may be displayed on the touch-screen. In step 126, the data elements, which are respectively given the tags of the same tag type, are arranged and displayed on the touch-screen by the data arrangement request of the user.

Next, FIG. 2 is a flowchart showing a method for user-adaptive data classification in a portable terminal according to an embodiment of the present invention.

FIG. 2 is a flowchart showing a method for user-adaptive data arrangement in a portable terminal according to an embodiment of the present invention.

Referring now to FIG. 2, in step 210, a current mode of the portable terminal is switched and set to a data classification mode, and a touch-screen displays all data elements stored in the portable terminal.

In step 212, a user checks through a user input means whether tags are to be given to predetermined data elements among the multiple data elements displayed on the touch-screen.

When the check result shows that the tags are respectively given to the predetermined data elements, the process proceeds to step 214. In step 214, the tags, which have been respectively given to the predetermined data in step 212, are identified. In this case, the tag given to each displayed data element signifies a letter or a numeral that a user writes in order to mark each displayed data element and is given a unique order. For example, the tags include A, B, C, D, . . . according to a unique arrangement order of capital English letters, a, b, c, d, . . . according to a unique arrangement order of small English letters, [symbol] , [symbol] , [symbol] , [symbol] , . . . according to a unique arrangement order of Hangeul, and 1, 2, 3, 4, . . . according to the ascending arrangement of natural numbers. At this time, the tags A, B, C, D, . . . have capital English letters as their tag type. The tags a, b, c, d, . . . have small English letters as their tag type. The tags [symbol] , [symbol] , [symbol] , [symbol] , . . . have Hangeul as their tag type. Therefore, the term “tag type” refers to a higher tag which has either English letters, Hangeul, Greek alphabet, numerals, etc. or multiple subordinate tag items of which priorities are set by the user. Also, when the tags, i.e. the multiple subordinate tag items, are classified into capital English letters, small English letters, Hangeul and the numerals, which are arranged in their unique priorities, each tag type having the multiple subordinate tag items is previously set and stored in the portable terminal at the time of initializing the portable terminal. The user gives the tag to each predetermined data element in step 212, and simultaneously, the type of the given tags is recognized.

Also, the tag, which is given to each displayed data element, is identified by comparing the tag, which is formed on each displayed data element that the user marks with his/her handwriting, based on images of the subordinate tag items (i.e. either A, B, C, D, . . . a, b, c, d, . . . or 1, 2, 3, 4, . . . ) according to the previously-designated tag types. Namely, when a data arrangement operation is initialized, the user directly inputs his/her own handwriting, and the subordinate tag items according the tag types are captured as images, respectively. The captured images of the subordinate tag items were previously stored. Otherwise, when the data arrangement operation is initialized, the portable terminal includes a database related to the tags, such as letters or numerals, arranged in their unique priorities. Accordingly, when the user marks the predetermined data elements by directly writing letters or numerals on them, the written letters or numerals as the tags are identified by comparing and checking them with the stored subordinate tag items according to the tag types.

In step 216, a search is made for whether tags having the same tag type as the identified tags have been previously stored in storage. When the search result shows that the tags having the same tag type exist, in step 218, the tags identified in step 214 are connected with previously-stored tags. For example, for the tag type of English capital letters, data elements may have been previously tagged with “A” and “B” additional capital letter use (“C”, “D”) can be a basis for connecting these items as part of a group.

In step 220, the currently-identified tags and the previously-stored tags, which are connected, are grouped as the same tag type. The tags grouped in step 220 are classified as the same tag type.

Meanwhile, when it is checked in step 212 that tags are not given to the predetermined data elements respectively, the process proceeds to step 224. In step 224, it is checked whether user interrupts occur with respect to the predetermined data elements. The “user interrupt” is classified as a user touch or an input interrupt, and signifies a user gesture occurring on the touch-screen through the user input means. The user gesture signifies the intention with which the user inputs information through an input unit such as the touch-screen, and implies that the user touches and points at any one point on the touch-screen.

In the portable terminal, the user gestures, for example, which may include a single tap for selecting or activating an object, a double tap for switching between display formats or switching a current screen to another one, a drag gesture of pressing and dragging one point without lifting the user input means off the one point to another location on the touch-screen, a pinch gesture of bringing two fingers having a distance therebetween close to each other on the touch-screen in order to reduce or make an object smaller, an unpinch gesture reverse to the pinch gesture, a flick gesture of flicking an object up and down on the touch-screen, a long touch press gesture of tightly pressing an object without lifting the user input means off the object on the touch-screen, etc.

In an exemplary embodiment of the present invention, a gesture which generates the user interrupt in step 224 is defined as a gesture from among the above user gestures, in which a user's finger corresponding to the user input means touches and drags the data element displayed on the touch-screen, and is then lifted off the displayed data element on the touch-screen.

Accordingly, when a user interrupt occurs with respect to the predetermined data element, the process proceeds to step 226. In step 226, a tag previously given to the predetermined data element is displayed. In step 228, it is checked whether the previously-given tag is to be modified to another tag depending on the selection of the user. At this time, another tag may be a tag having the same tag type as the previously-given tag or a tag having a different tag type from that of the previously-given tag. When it is checked in step 228 that the previously-given tag is to be modified to another one, the process returns to step 212. In step 212, a subsequent operation is performed.

At this time, the tag modification is performed by deleting the tag previously given to the relevant data element through the user interrupt and giving a new tag to the relevant data element of which the previously-given tag has been deleted.

When the tags having the same tag type do not exist based on the result of the search made in step 216 for whether the tags having the same tag type as the identified tags have been previously stored, the process proceeds to step 230. In step 230, the tag type of the identified tags is defined. The tag type defined by the user signifying a higher tag including multiple subordinate tag items, such as either English letters, Hangeul or numerals, of which priorities are set. Each user using a portable terminal may define and register subordinate tag items according to specialized tag types.

In step 222, the tags, which are respectively given to the predetermined data elements having the tag type defined by the user, are classified as the user-defined tag type. Then, the predetermined data elements having the tag type defined by the user are classified as data elements of the user-defined tag type.

Hitherto, the above description has been made of the method for user-adaptive data arrangement/classification in the portable terminal according to an exemplary embodiment of the present invention.

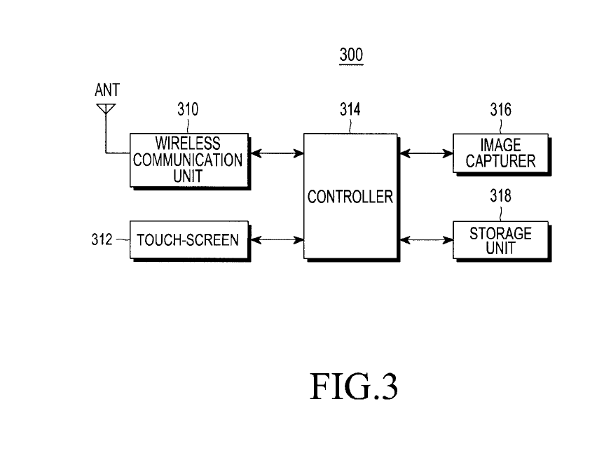

Hereinafter, a user-adaptive data arrangement/classification apparatus in a portable terminal according to another exemplary embodiment of the present invention will be described above with reference to FIG. 3.

FIG. 3 is a block diagram illustrating the configuration of a user-adaptive data arrangement/classification apparatus in a portable terminal. Referring now to FIG. 3, a user-adaptive data arrangement/classification apparatus 300 of the portable terminal preferably includes a wireless communication unit 310, a touch-screen 312, a controller 314, an image capturer 316, and a storage unit 318. Besides the items shown in FIG. 3, the portable terminal according to the presently claimed invention may further include a camera, a speaker, etc.

The wireless communication unit 310 receives a wireless downlink signal from the air through an antenna, and outputs downlink data, which is obtained by demodulating the wireless downlink signal, to the controller 314. Also, the wireless communication unit 310 modulates uplink data, which is input from the controller 314, and generates a wireless uplink signal. Then, the wireless communication unit 310 wirelessly transmits the generated wireless uplink signal to the air through an antenna. It is desirable and preferable that the modulation and the demodulation may be performed in a CDMA (Code Division Multiple Access) scheme. However, the modulation and the demodulation may be performed in virtually any wireless system, including an FDM (Frequency Division Multiplexing) scheme, a TDM (Time Division Multiplexing) scheme, etc., just to name a few possibilities.

The touch-screen 312 may output a sensing value (pressure, resistance, and electrostatic capacitance) according to operation schemes (pressure, resistive, electrostatic capacity, etc.) to the controller 314. Other than this, it may generate a user touch or an input interrupt.

Also, the touch-screen 312 displays data in the portable terminal under the control of the controller 314. When the surface thereof is touched by a user input means such as a finger or a stylus pen, the touch-screen 312 generates a user touch or an input interrupt. Then, the touch screen outputs the user input information to the controller 314 under the control of the controller 314.

When tags are respectively given to predetermined data elements among all data elements displayed on the touch-screen 312, the image capturer 316 captures each predetermined data element, which is given a tag, as a single image under the control of the controller 314.

The controller 314 displays all of the data elements on the touch-screen 312, sets arrangement priorities of the displayed data elements by giving a tag to each displayed data element, controls the image capturer 316 to capture each displayed data element given a tag as an image, identifies the tag given to each displayed data element, arranges the captured images in unique priorities for each type of the tags and controls the storage unit 318 to store the arranged images, and the stored images respectively given tags are grouped according to the tag types.

Also, when a user gives a tag to at least one data element from among the data elements displayed on the touch-screen 312, the controller 314 identifies the tag given to the at least one data element, and searches for whether tags, which have the same tag type as the identified tag, have been previously stored. When the search result shows that the tags having the same tag type exist, the controller 314 connects the identified tag with previously-stored tags, and groups and classifies the identified tag as the same tag type.

The storage unit 318 stores application programs having various functions and images for providing a Graphic User Interface (GUI) related to the application programs, databases related to user information, documents, etc., background images (i.e. menu screen images, idle screen images, etc.) needed to drive the portable terminal, and/or operating programs.

Implementation as described above may be made of the method and the apparatus for user-adaptive data arrangement/classification in the portable terminal according to the exemplary embodiments of the present invention, but the aforementioned exemplary embodiments were provided merely for illustrative purposes and not to limit the claimed in invention to the examples shown and described.

While the present invention has been shown and described with reference to certain exemplary embodiments thereof, it will be understood by those skilled in the art that various changes in form and details may be made therein without departing from the spirit and scope of the invention. Therefore, the spirit and scope of the present invention must be defined not by the described embodiments thereof but by the breadth of the appended claims and equivalents thereof.

As described above, by directly writing letters or numerals on a touch-screen displaying multiple data elements stored in a portable terminal in order to mark them, a user can adaptively and easily arrange/classify the multiple displayed data elements, departing from a scheme for arranging and classifying multiple data elements in a lump based on the existing file names, file generation dates, data sizes, etc. As a result, data search time is reduced, and the user can quickly access desired data.

The above-described methods according to the present invention can be realized in hardware, as software, firmware or computer code that can be stored in a recording medium such as a CD ROM, an RAM, a floppy disk, a hard disk, or a magneto-optical disk or downloaded over a network, so that the methods described herein can be rendered in such software using a general purpose computer, microprocessor (i.e. controller), or a special processor or in programmable or dedicated hardware, such as an ASIC or FPGA. As would be understood in the art, the computer, the processor or the programmable hardware include memory components, e.g., RAM, ROM, Flash, etc. that may store or receive software or computer code that when accessed and executed by the computer, processor or hardware implement the processing methods described herein.

What is claimed is:

1. A method for user-adaptive data arrangement in a portable terminal, the method comprising:
displaying by a touch screen a plurality of data elements stored in the portable terminal,
setting arrangement priorities of a least a user-designated portion of the displayed data elements by a controller in response to a detecting a respective tag arranged on one or more displayed data elements of the plurality of data elements;
capturing by an image capturer each displayed data element having the respective tag arranged thereon as a captured image;
identifying the respective tag associated with a particular displayed data element, and arranging and storing a plurality of captured images in which each captured image having at least one tag of a plurality of respective tags according to unique priorities associated with each type of respective tag; and
grouping the stored captured images according to each type of the respective tags.

2. The method as claimed in claim 1, wherein, in detecting the respective tag being arranged on one or more displayed data elements includes detecting by a touchscreen a user mark comprising the respective tag arranged on one or more displayed data elements that is written by a user input means on the particular displayed data element.

3. The method as claimed in claim 1, wherein the respective tags comprise letters or numerals given a unique order which are written on the touch screen in order to tag the displayed data elements.

4. The method as claimed in claim 1, wherein an order of arranging the respective tags according to the types comprises a unique arrangement order when the respective tags comprise letters, and is an ascending order when the tags comprise numerals.

5. The method as claimed in claim 1, wherein the respective tags comprise alphanumeric characters.

6. The method as claimed in claim 1, wherein the respective tag arranged on each particular displayed data element is identified by identifying the respective tag formed on each particular displayed data element that is marked by writing the tag, based on images of subordinate tag items according to the previously-designated tag types.

7. The method as claimed in claim 1, further comprising:
displaying only the plurality of data elements that are associated respective tags of a selected tag type, when a request is received for arranging a display of data elements of a particular tag type.

8. A method for user-adaptive data classification in a portable terminal, the method comprising:
displaying by a display data elements stored in a storage of the portable terminal, and receiving a particular tag associated by a user with at least one data element from among the displayed data elements;
identifying by a controller the particular tag associated with the at least one data element, and searching for whether other tags of an equal tag type as the particular tag have been previously stored; and
associating by the controller the identified particular tag with the other previously-stored tags, and grouping and classifying the identified particular tag as being of an equal tag type as the other previously-stored tags, when a result of the search shows that other tags having the equal tag type exist in storage.

9. The method as claimed in claim 8, wherein the tag type comprises a higher order tag which has either English letters, Hangeul, numerals or multiple subordinate tag items of which priorities are set by a user.

10. The method as claimed in claim 8, further comprising:
previously storing a tag type having multiple subordinate tag items.

11. The method as claimed in claim 8, wherein when the result of the searching for whether other tags of an equal tag type as the particular tag have been previously stored results in a determination that the tags having the equal tag type do not exist, a new tag type is defined for and is allocated to the particular tag associated with the at least one data element.

12. The method as claimed in claim 8, further comprising:
recognizing a type of particular tag simultaneously while receiving by the user the tags respectively associated with respective displayed data elements.

13. The method as claimed in claim 8, wherein the tag associated with the at least one displayed data element is identified by detecting the tag that is formed on at least one displayed data element by user marks written on the displayed data element, and based on images of subordinate tag items according to the previously-designated tag types.

14. The method as claimed in claim 8, further comprising:
displaying a tag previously associated with a particular data element and modifying the previously-associated tag in accordance with a user selection, wherein a user touch interrupt on the touch screen occurs with respect to the particular data element from among the displayed data elements on the display unit of the portable terminal.

15. An apparatus for user-adaptive data arrangement/classification in a portable terminal, the apparatus comprising:
a touch-screen for displaying a plurality of elements thereon;
an image capturer for capturing an image of particular elements displayed in the touch screen; and
a controller for controlling displaying the plurality of data elements on the touch-screen, and for setting arrangement priorities of the displayed plurality of data elements in response to a respective tag of a plurality of tags respectively arranged on a particular data element of the plurality of displayed data elements, and for controlling the image capturer to capture each displayed data element tagged as an image by the user, and for identifying the respective tag associated with a particular displayed data element, and for arranging the captured images in unique priorities for each type of the tags and for controlling a storage unit to store the arranged images, and for grouping the stored images associated with respective tags according to the tag types.

16. The apparatus as claimed in claim 15, wherein when a respective tag is associated with at least one data element among the data elements displayed on the touch-screen, the controller identifies the respective tag associated with the at least one data element, and searches for whether tags having an equal tag type exist in storage; and when the search results in a determination that tags having the equal tag type exist, the controller connects the identified tag with previously-stored tags, and groups and classifies the identified tag as the equal tag type.

17. The apparatus as claimed in claim 15, wherein the respective tag is associated with at least one of each displayed data element based on user marks directly written on a respectively displayed data element via a user input means.

18. The apparatus as claimed in claim 15, wherein the respective tags comprise letters, numerals or alpha numeric characters associated in a unique order written by the user in order to tag the respective displayed data elements.

19. The apparatus as claimed in claim 15, wherein the respective tag associated with each displayed data element is identified by comparing the tag arranged on each displayed data element by user-written marks based on images of subordinate tag items according to the previously-designated tag types.

20. The apparatus as claimed in claim 15, wherein when the search results in a determination that the tags having the equal tag type do not exist, a new tag type is defined for and is allocated to the tag associated with the at least one data element.
